(19) United States
(12) Patent Application Publication
(10) Pub. No.: US 2013/0011640 A1
(43) Pub. Date: Jan. 10, 2013

(54) SUNSHADE CURTAIN

(75) Inventor: Paul Lin, Tainan City (TW)

(73) Assignee: MACAUTO INDUSTRIAL CO., LTD, Tainan City (TW)

(21) Appl. No.: 13/540,950

(22) Filed: Jul. 3, 2012

(30) Foreign Application Priority Data
Jul. 5, 2011 (TW) 100123657

(51) Int. Cl. B32B 27/04

(52) U.S. Cl. 428/198

(57) ABSTRACT

A sunshade curtain includes a first layer, a second layer spaced apart from the first layer, a light shading layer disposed between the first and second layers, and two gluing layers respectively adhering the first and second layers to two opposite sides of the light shading layer. Each of the gluing layers includes a plurality of glue spots spaced apart from each other.

### CROSS-REFERENCE TO RELATED APPLICATION

This application claims priority to Taiwanese Application No. 100123657, filed on Jul. 5, 2011.

### BACKGROUND OF THE INVENTION

1. Field of the Invention

The invention relates to a sunshade curtain, and more particularly to a sunshade curtain having a light shading layer attached with gluing layers and adapted for placement on an inside surface of a window for sun shading.

2. Description of the Related Art

Conventional sunshade curtains tend to have different structures and configurations depending upon requirements for different sun shading levels. The conventional sunshade curtains f or mounting on a window inside a vehicle may be configured as a winding device or a drapery. These conventional sunshade curtains frequently have two structural layers woven from yarns and a glue coating for adhering the two structural layers to each other. Although the conventional sunshade curtains may have aesthetic appeal and sun-shading characteristics with the two woven structural layers, the structural layers made by weaving may generate a plurality of crevices among the yarns, which, in use, may generate problems of light leaking and poor sun shading property.

In addition, for the conventional sunshade curtains, the purpose of firmly bonding the woven structural layers together is achieved through the glue coating. However, the glue coating tends to thoroughly penetrate into the whole woven structural layers, such that under a relatively low temperature, the conventional sunshade curtains tend to be stiff and difficult to wind. Moreover, the conventional sunshade curtains may wrinkle due to uneven dried shrinking of the glue coating, creating an additional defect.

### SUMMARY OF THE INVENTION

Therefore, an object of the present invention is to provide a sunshade curtain that can at least alleviate the aforesaid drawbacks of the prior art.

According to the present invention, a sunshade curtain includes a first layer, a second layer spaced apart from the first layer, a light shading layer disposed between the first and second layers, and two gluing layers respectively adhering the first and second layers to two opposite sides of the light shading layer. Each of the gluing layers includes a plurality of glue spots spaced apart from each other.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a sunshade curtain according to the present invention; and

FIG. 2 is a fragmentary sectional view of the preferred embodiment of FIG. 1.

### DETAILED DESCRIPTION OF THE PREFERRED EMBODIMENT

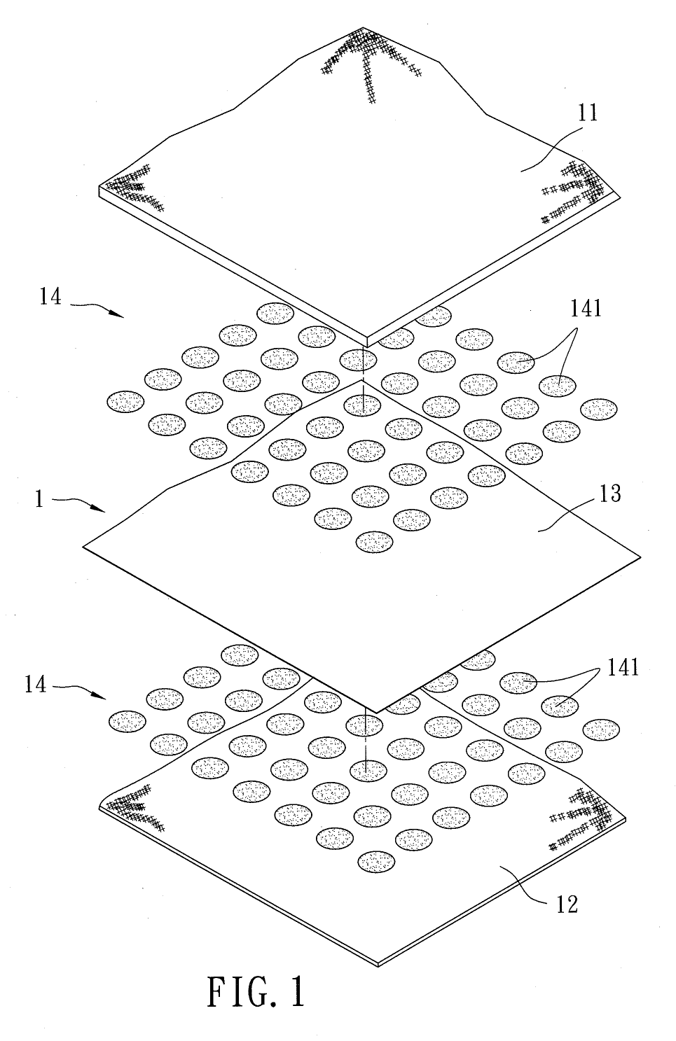

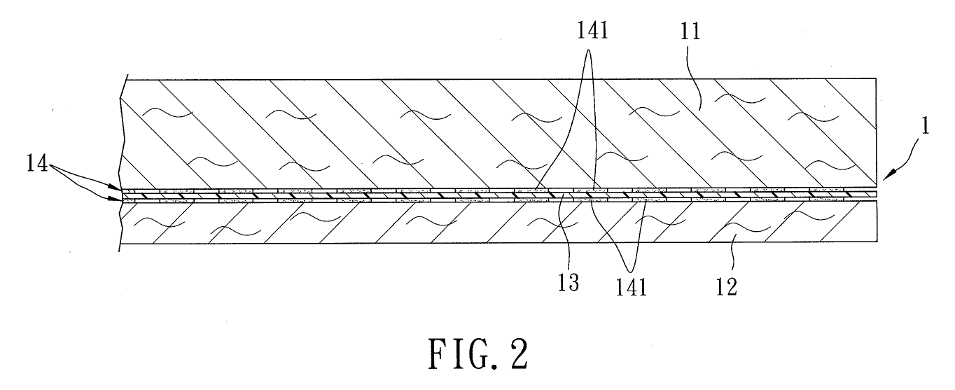

Referring to FIGS. 1 and 2, the preferred embodiment of a sunshade curtain 1 of the present invention is illustrated. The sunshade curtain 1 is adapted for being disposed inside a vehicle. Particularly, the sunshade curtain 1 may be configured as a winding device and disposed under a sun roof of the vehicle. The sunshade curtain 1 includes a first layer 11 that has a woven structure a second layer 12 that has a woven structure and that is spaced apart from the first layer 11, a light shading layer 13 that is disposed between the first and second layers 11, 12, and two gluing layers 14 that respectively adhere the first and second layers 11, 12 to two opposite sides of the light shading layer 13.

In this embodiment, the first layer 11 has a relatively good weather resistance and is made by weaving yarns. The yarns are made from a first plastic material selected from the group consisting of polyethylene glycol terephthalate, polyester and combinations thereof. The second layer 12 is also made by weaving yarns that are made from the same material as that for making the first layer 11. The second layer 12 may have a woven pattern similar to or different from that of the first layer 11. For achieving a better thermal insulation effect, the second layer 12 may be made from a black woven fabric while the first layer 11 may be a gray woven fabric. According to this embodiment, the light shading layer 13 is a white film having a light shading effect and is made from a second plastic material selected from the group consisting of polyurethane (PU), thermoplastic urethane elastomer (TPU) and combinations thereof.

Preferably, the first layer 11 has a thickness greater than that of the second layer 12, and the thickness of the second layer 12 is greater than that of the light shading layer 13.

Preferably, in order to improve the softness of the sunshade curtain 1, the thickness of the first layer 11 ranges from 0.2 mm to 0.6 mm, the thickness of the second layer 12 ranges from 0.05 mm to 0.25 mm, and the thickness of the light shading layer 13 ranges from 0.11 mm to 0.13 mm.

Preferably, each of the gluing layers 14 includes a plurality of glue spots 141 distributed uniformly.

By virtue of a structural design involving interposition of the light shading layer 13 that has a relatively poor weather resistance between the first and second layers 11, 12 that have texture and relatively qood weather resistance and further involving adhesion of the first, second and light shading layers 11, 12, 13, via the gluing layers 14 that have the plurality of glue spots 141, the sunshade curtain 1 of this invention is not only innovative, but the light shading effect thereof can also be enhanced without adversely affecting the aesthetic appeal thereof.

Moreover, since the gluing layers 14 used for adhering the first and second layers 11, 12 to the light shading layer 13 include the plurality of uniformly distributed glue spots 141, the first and second layers 11, 12 can be firmly bonded to the light shading layer 13 while improving upon the stiffness problem encountered by the conventional sunshade curtains. Besides, within the abovementioned thickness limitations, the sunshade curtain 1 of this invention tends to have an enhanced softness so that the sunshade curtain 1 can be easily wound and have fewer wrinkles.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sunshade curtain, comprising:
a first layer;
a second layer spaced apart from said first layer;
a light shading layer disposed between said first and second layers; and
two gluing layers respectively adhering said first and second layers to two opposite sides of said light shading layer;
wherein each of said gluing layers includes a plurality of glue spots spaced apart from each other.

2. The sunshade curtain as claimed in claim 1, wherein each of said first and second layers is a woven fabric made from a first plastic material that is selected from a group consisting of polyethylene glycol terephthalate, polyester and combinations thereof; and
wherein said light shading layer is in the form of a film and is made from a second plastic material selected from the group consisting of polyurethane (PU), thermoplastic urethane elastomer (TPU) and combinations thereof.

3. The sunshade curtain as claimed in claim 2, wherein said first layer has a thickness greater than that of said second layer, the thickness of said second layer being greater than that of said light shading layer.

4. The sunshade curtain as claimed in claim 3, wherein the thickness of said first layer ranges from 0.2 mm to 0.6 mm, the thickness of said second layer ranges from 0.05 mm to 0.25 mm, and the thickness of said light shading layer ranges from 0.11 mm to 0.13 mm.

5. The sunshade curtain as claimed in claim 1, wherein said first layer has a thickness ranging from 0.2 mm to 0.6 mm, said second layer has a thickness ranging from 0.05 mm to 0.25 mm, and said light shading layer has a thickness ranging from 0.11 mm to 0.13 mm.
